(19) United States
(12) Patent Application Publication
(10) Pub. No.: US 2013/0168225 A1
(43) Pub. Date: Jul. 4, 2013

(54) Distiller with Closed Loop Energy Circulation and Method for Reuse of Heat Energy and Thermal Loss of the Distiller

(71) Applicants: Tarmo Oikimus, Tallinn (EE); Konstantin Oikimus, Tallinn (EE); Mart Eensalu, Tallinn (EE)

(72) Inventors: Tarmo Oikimus, Tallinn (EE); Konstantin Oikimus, Tallinn (EE); Mart Eensalu, Tallinn (EE)

(73) Assignee: HEAT RECYCLERS, OU, TALLINN (EE)

(21) Appl. No.: 13/821,724

(22) PCT Filed: Sep. 8, 2011
(86) PCT No.: PCT/IB11/02105

§ 371 Date: Mar. 8, 2013

(30) Foreign Application Priority Data
Sep. 10, 2010 (EE) P201000071

(51) Int. Cl. B01D 3/00

(52) U.S. Cl. CPC B01D 3/007
USPC 203/24; 202/180

(57) ABSTRACT

The aim of the invention is to improve the energetic efficiency of the distiller by effective utilization of the residual heat. The invention relates to distillator with a thermal energy recycling in the closed loop energy circulation and to methods for thermal energy recycling of the distiller by returning the residual heat to the initial environment via the heat pump. The invention also further relates to reuse of the heat loss of the distiller using the heat pump which returns the residual heat to the initial environment. In distillers and methods according to present invention the heat energy and thermal losses are used repeatedly again in a closed loop energy circulation. If the problem of intensive energy consumption is resolved the distiller according to this invention can be appropriately utilized for instance in production of drinking water from the seawater or from any available natural water, as well as at the finishing stage of the noncomplicated wastewater treatment process. The closed loop energy circulation is also applicable in production of spirit, biofuel-spirit, and petrochemicals based on the same principle, reducing considerably the energy intensiveness of these products.

### TECHNICAL FIELD

The object of the invention is a distiller with closed loop energy circulation and a method for the reuse of the heat energy and thermal loss of the distiller.

### PRIOR ART

The distiller is an efficient separator of the components of solutions. With a distiller, the components of solutions are separated into condensate and concentrate. For this purpose the solution is heated until the boiling point and the vapour is condensed into condensate in the condenser. However, the weakness of the distiller is its high energy consumption.

From the prior art there is known a distiller and the method of its use, presented in patent application GB962136 (published on 01.07.1964). This solution does not use neither the heat pump nor the additional heat exchanger and the whole heat is not efficiently utilised in the reuse of residual heat.

### DESCRIPTION OF THE INVENTION

The objective of this invention is to improve the energy efficiency of the distiller, which is expressed in finding an efficient application for residual heat. The energy used for heating and evaporating the solution transfers to the coolant in the condenser and is the residual heat that is extracted from the system by the coolant. Thus, the distillation requires constantly additional energy simultaneously with cooling. Finding an application for this energy improves the energetic efficiency of the distiller.

If distillation is the only objective, then the best solution for saving energy is to use low-temperature the solution to be distilled, which requires heating and is pumped into the distiller, for condensing the vapour coming from the boiling vessel of the distiller and for the cooling of the condensate and concentrate in the condenser cooler. Therefore, according to the invention, the condenser cooler does not use the separate cooling water, which is taking the energy used in the boiling vessel out from the system, but the solution to be distilled.

The condenser is a heat exchanger, on one side of the heat exchanging surface moves the cooling water with a low temperature, while on the other side of the heat exchanging surface, the vapour coming from the boiling vessel moving in the opposite direction. According to the invention, a coil of the concentrate coming from the boiling vessel is added to the condenser of the distiller. In such form the condenser is the pre-heater of the solution to be distilled and the condenser of the vapour coming from the boiling vessel, and the cooler of the condensate and the concentrate.

The energy circulation of the distiller can also be executed by means of separate coolers for the condenser, condensate and concentrate. The principle is the same—the energy contained in the vapour from the boiling vessel and in the concentrate is transferred to the solution to be distilled moving to the distiller. By condensing the vapour in the condenser by means of the solution to be distilled and cooling the condensate and concentrate, the energy used for the heating and evaporation of the distilled solution is transferred back to the solution to be distilled. The energy, which has once been used, is reused in the closed loop energy circulation between the boiling vessel of the distiller and the condenser cooler.

In an ideal process, the hot vapour, condensate and concentrate coming from the boiling vessel of the distiller heat up the solution to be distilled in the condenser of the distiller, which is moving on the other side of the heat exchanging surface of the condenser, while the cold solution to be distilled condenses the vapour, cools the condensate and concentrate. The energy used for the heating and evaporation of the solution is equal to the energy released with condensation and the cooling of the condensate and concentrate. The actual process always involves heat losses and temperature differences of environments in the heat exchange.

Qₛ=Qⱼₐ+Qⱼₖ+Qₛₖ

Qₛ—energy used for the heating and evaporation of the solution to be distilled
Qⱼₐ—energy released with the condensation of vapour and cooling of the condensate
Qⱼₖ—energy released with the cooling of the concentrate
Qₛₖ—heat losses of the distiller

In order to bring the distilled solution in the boiling vessel to the boiling point, the energy volume transferred to the boiling vessel by means of the heat pump condenser should have somewhat higher temperature than the boiling temperature. As the energy contained in the vapour, condensate and concentrate is transferred to the solution to be distilled going to the boiling vessel in the course of the heat exchange occurring in the condenser cooler, the temperature of the solution to be distilled remains somewhat lower from the temperature of the vapour and concentrate. The temperature of the condensate and concentrate flowing out from the condenser cooler remains somewhat higher from the temperature of the solution to be distilled. For example, if distilling at the normal pressure, the boiling temperature is 100° C., the temperature of the solution to be distilled 15° C. The area of the heat exchange surface of the condenser cooler and the flow rate of the media in the heat exchange of the condenser cooler are selected so that the temperature difference of environments in the heat exchange would be 5° C. The temperature of the heat pump condenser in the boiling vessel is 105° C. The temperature of the vapour and concentrate coming to the condenser cooler 10 is 100° C. and 20° C. when coming out from condenser cooler 10. The solution to be distilled is 15° C. when entering the condenser cooler and 95° C. when discharged. The solution to be distilled enters the boiling vessel at the temperature of 95° C., if not taking into account the heat losses in the boiling vessel, connection pipes and condenser cooler. In case of a regular distiller, the distilled solution should be heated from 15° C. to 100° C. In case of the distiller with a closed loop energy circulation, the pre-heated solution to be distilled needs to be heated from 95° C. to 100° C. The energy required for this can be retrieved by means of the heat pump from the condensate and concentrate following the condenser cooler, which are at the temperature of twenty degrees. The condensate and concentrate coming from the condenser cooler and being at the temperature of twenty degrees, are guided through the heat pump evaporator, after which the temperature of the discharged condensate and concentrate is 10° C. The heat pump compressor pumps the energy, which had transferred from the condensate and concentrate into the coolant in the heat pump evaporator, to the heat pump condenser in the boiling vessel. The temperature of the heat pump condenser in the boiling vessel is 105° C. and the energy circulation starts the next loop.

The energy requirement for generating the temperature difference needed for the functioning of the distiller and for compensating energy losses is much lower than in case of the whole energy used for the heating and evaporation of the solution in a regular distiller. Heat losses are further reduced by means of proper thermal insulation.

Several sources of energy are viable for the functioning of the distiller corresponding to this invention. If the distiller is heated with a heat pump (such as air heat pump), which returns residual heat to the initial environment and which includes a second parallel evaporator added to it, the environment of which for the retrieving of energy is the energy in the condensate and concentrate following the condenser cooler and remaining above the freezing point, occurs a situation with surplus energy after the distillation of the solution. This provided that the initial temperature of the distilled solution and consequently the temperature of the concentrate and condensate is sufficiently higher than the freezing temperature.

Upon starting the distiller, the energy for heating up the boiling vessel of the distilled solution is retrieved from the air by means of the heat pump evaporator. The energy necessary for maintaining a continued distillation process can be retrieved by means of the heat pump evaporator from the residual energy in the concentrate and condensate, which exceed the freezing level, or from the air by means of the heat pump evaporator. If the heat pump is used only for compensating for the heat loss and for creating the difference in temperature necessary for the functioning of the heat exchange, the temperature of the condensate and concentrate is lower by a few degrees from the initial temperature of the solution to be distilled as the result of the distillation. When heating the distiller with a heat pump, the actual thermal coefficient of power consumption is several times smaller than the temperature used for creating the temperature difference necessary for maintaining the distillation process and for the compensation of heat losses. The energy in the condensate and concentrate exceeding the freezing level could also be used for other purposes with the help of the heat pump. In case of environments with different temperatures, the environment with a higher temperature could be used for heating the environment with the lower temperature, until the temperatures of the environments in the heat exchange have become equal.

In addition to the pursued heat exchange, there always exists the energy that escapes from the heat exchange system, namely the heat loss, reduction of which would be sensible. For the reduction of heat losses, hot equipment are isolated from the cooler environment by means of thermal insulation materials. All materials conduct heat, some better and some worse. Materials with low heat conductivity are used as thermal insulation materials. The insulation principle of thermal insulation materials consists of holding some gaseous material by means of several partition walls, such as hardened foam. Increasing the thickness of a thermal insulation layer reduces heat losses. The minor heat losses penetrating good thermal insulation could be recycled in the pr-heating of a solution to be distilled with a lower temperature or in heating the air going to an air heat pump evaporator used for the heating of the distiller, in other words—energy losses could be routed back to the energy circulation inside the distiller.

The solution to be distilled is pre-heated by the extent of the heat loss, as a result of which the heat loss also remains within the energy circulation inside the distiller. Heating of the air, which moves to the evaporator of the air heat pump by the extent of the heat loss increases the evaporation temperature of the heat pump coolant in the evaporator by the same extent. With this method, heat losses are circulated in the energy circulation inside the distiller by the mediation of the heat pump. The functioning of heat exchange requires environments with different temperatures and a contact surface between the environments. The intensity of heat exchange is determined by the temperature difference of the environments engaged in heat exchange and by the thermal conductivity of the contact surface. The temperature inside the boiling vessel of the distiller corresponds to the pressure selected for the distillation. Inside the internal thermal insulation casing is the temperature of the heat loss penetrating the wall of the boiling vessel, on the outer surface of the thermal insulation casing the temperature of the heat loss penetrating the insulation. Between the two insulation casings is the solution to be distilled pre-heated by the extent of the heat loss penetrating the internal thermal insulation casing, or the air heated by the extent of heat loss, moving towards the heat pump evaporator and surrounding the distiller. When the environment between the thermal insulation casings remains still, the environment heats up and the heat exchange continues towards the environment with the lower temperature.

Reuse of heat losses is based on the movement of the environment between thermal insulation casings. The solution to be distilled moves from the inlet to a water jacket, warming up by the extent of heat losses in the course of moving through it. From the water jacket the solution moves to the condenser cooler of the distiller, where it is heated by the extent of the energy of the vapour, condensate and concentrate. From the condenser cooler the pre-heated solution to be distilled continues to the boiling vessel of the distiller, where it is heated up to the boiling point by means of the heat pump condenser. From the boiling vessel the distilled solution moves in the form of vapour and concentrate once more to the condenser cooler of the distiller, where the vapour condenses and the condensate together with the concentrate cool down, while warming the distilled solution passing through the condenser cooler in the opposition direction. From the condenser cooler the condensate and concentrate move to the heat pump evaporator, from where the remaining energy in the condensate and concentrate is pumped by means of a heat pump to the boiling vessel of the distiller. The condensate and concentrate exit from the heat pump evaporator through outlets. The solution to be distilled passes through the distiller inlet, through the water jacket, through the medium of the condenser cooler, boiling vessel, through the condensate coil in the condenser cooler, through the condensate outlet of the condensate coil in the heat pump evaporator, and in the condensate cooler through the concentrate spiral in the heat pump evaporator, through the concentrate outlet of the concentrate coil once in a continuous flow. The energy used in the distillation is then again in a circulation loop between the boiling vessel and the condenser cooler, and the share of energy not transferred in the condenser cooler due to the temperature difference occurring in heat exchange is transferred by means of the heat pump from the heat pump evaporator to the boiling vessel for circulation inside the distiller.

The flow rate of the distilled solution in the water jacket between the thermal insulation casings is mainly determined by the speed of distillation and the cross-section area of the water jacket. In the second case the air flow rate between the thermal insulation casings depends on the distillation speed provided by the heat pump, the air is guided through the heat pump evaporator. The volume of recycled heat loss depends mainly on the ratio of the quantity of the environment moving between the thermal insulation casings and the heat loss contingent on the thermal conductivity and thickness of the thermal insulation material. The difference between temperatures on the internal and outer surface of an internal casing with good thermal insulation properties is high (see points b, c and f in FIG. 4), since the heat loss escaping through a thermal insulation casing with low thermal conductivity is low. Low heat loss heats the environment moving between the thermal insulation casings only a little, resulting in a small difference between the temperature of internal and outer surface of the external thermal insulation casing (see points d, g, e and h in FIG. 4), since the environment between the casings is continuously replaced with the cooler solution to be distilled or the ambient air of the distiller. The heat loss through the external thermal insulation casing remains much lower than the heat loss through the internal casing, since the difference of the temperatures of the internal and outer surface of the external casing is small. If selecting for the internal thermal insulation casing a thermal insulation material, which has a higher thermal conductivity and/or is thinner, the heat loss through the thermal insulation casings would be respectively higher. The heat loss through the external thermal insulation casing would increase less, since the environment between the thermal insulation casings is replaced due to the movement of the environment. The difference of temperatures of the internal and outer surface of the external thermal insulation casing remains small.

In the pursuit of higher efficiency in energy use, heat losses could be recycled similarly also in other energy applications, such as in buildings with economic energy use, which feature an air gap between the main wall structure and the external lining, in case of windows with triple glazing the outer gap between glass panes is ventilated, doors have air canals and the air heat pump is used for heating.

### LIST OF FIGURES

FIG. 1 presents a distiller with closed loop energy circulation, comprising the parts of the heat pump and distiller. The part of the heat pump comprises heat pump compressor 1, heat pump condenser 2, additional air heat exchanger 4 and air heat evaporator 6 and a parallel evaporator of condensate and concentrate heat exchanger 7, fan 3, expansion valves 5, condensate coil 8 and concentrate coil 9 in the evaporator of condensate and concentrate heat exchanger 7. The part of the distiller comprises the condenser cooler 10, condenser coil 11 of the condenser cooler 10 of the distiller, concentrate coil 12 of the condenser cooler 10 of the distiller, boiling vessel 13 of the distiller, inlet 14a for the solution to be distilled, condensate outlet 15 and concentrate outlet 16.

FIG. 2 presents the distiller presented in FIG. 1, comprising additionally the internal thermal insulation casing 18 of the distiller, external insulation casing 19 of the distiller, inlet 14b for the solution to be distilled and the water jacket 17a of the solution to be distilled between thermal insulation jackets 18 and 19.

FIG. 3 presents the distiller presented in FIG. 1, comprising additionally the internal thermal insulation casing 18 of the distiller, external insulation casing 19 of the distiller, the air gap 17b remaining between thermal insulation casings 18 and 19, air inlet 20 of the heat pump and air outlet 21 of the heat pump. According to this preferred embodiment, also fan 3, heat pump heat exchanger 4 and heat pump evaporator 6 are inside the external thermal insulation casing 19. Heat losses from the hot parts of the distiller, which penetrate thermal insulation 18, heat up the air moving in the air gap 17b inside the external thermal insulation casing 19 towards the heat pump heat exchanger 4 and heat pump evaporator 6, giving the possibility to recycle heat losses.

FIG. 4 presents heat loss diagrams about the movement of heat at the fixed cross-section of the distiller by the heat pump air inlet 20 and in front of additional heat pump heat exchanger 4, presented in FIG. 3. The fixed cross-section of the distiller indicates the wall of the boiling vessel 13 of the distiller, internal thermal insulation casing 18 of the distiller, external thermal insulation casing 19 of the distiller and the air gap 17b between the thermal insulation casings 18 and 19.

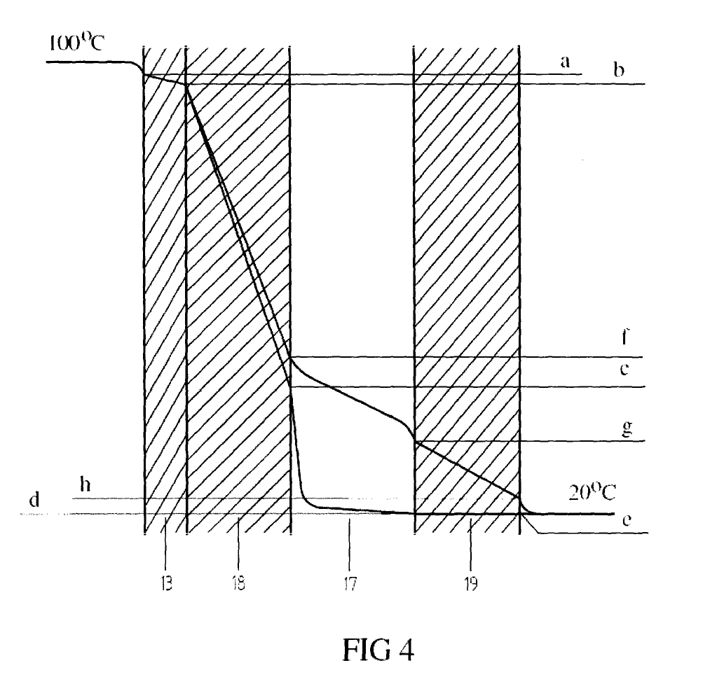

The passing of heat through the structures shown by heat pump air inlet 20 in the fixed cross-section are presented as a heat loss diagram from point a as a heat loss diagram line of the distiller from the inner surface of the boiling vessel 13 of the distiller, through the heat loss diagram line point b of the distiller on the external wall of the boiling vessel 13 of the distiller and also on the inner surface of the internal thermal insulation casing 18 of the distiller, through the heat loss diagram line point c of the distiller on the outer surface of the internal thermal insulation casing 18 of the distiller, through the heat loss diagram line point d of the distiller on the inner surface of the external thermal insulation casing 19 of the distiller until the heat loss diagram line point e of the distiller on the outer surface of the external thermal insulation casing 19.

The passing of heat through the structure shown in front of the additional heat pump heat exchanger 4 in the fixed cross-section are presented as a heat loss diagram from point a as a heat loss diagram line from point a on the inner surface of the boiling vessel 13 of the distiller, through heat loss diagram line point b of the distiller on the external wall of the boiling vessel 13 of the distiller and also on the inner surface of the internal thermal insulation casing 18 of the distiller, through the heat loss diagram line point f of the distiller on the outer surface of the internal thermal insulation casing 18 of the distiller, through the heat loss diagram line point f on the inner surface of the external thermal insulation casing 19 of the distiller, until heat loss diagram line point h of the distiller, on the outer surface of the external thermal insulation casing 19 of the distiller.

To simplify the explanation of the movement of heat loss, the inner surface temperature of the internal thermal insulation casing 18 is indicated as the same over the whole inner surface. The diagrams of the fixed cross-sections of the distiller, selected in the area between the cross-section of air inlet 20 of the heat pump until the cross-section place of the additional heat exchanger 4 of the heat pump remain between the diagrams shown in the figure.

### PREFERRED EMBODIMENTS OF THE INVENTION

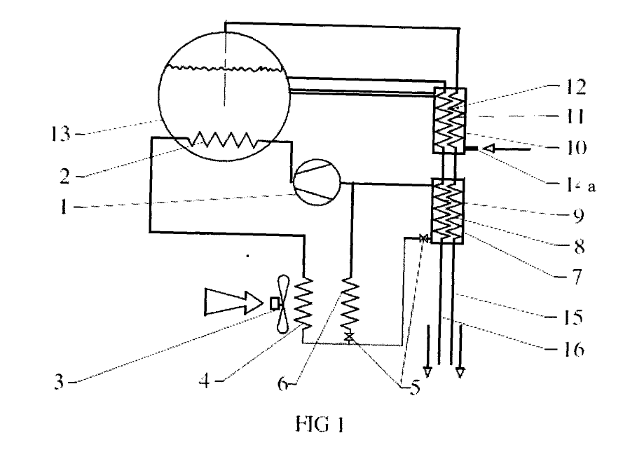

According to the preferred embodiment presented in FIG. 1, when selecting for the heating of the distiller a heat pump that returns residual heat to the initial environment, supplied with an additional parallel evaporator of the condensate and concentrate heat exchanger 7, with the initial energy source the energy contained in the condensate and concentrate after the condenser cooler 10 of the distiller, a situation with surplus energy is achieved, provided that the initial temperature of the solution to be distilled and consequently, the temperature of the concentrate and condensate is sufficiently higher than the freezing temperature. The energy, which is contained in the coolant and exceeds the evaporation temperature in the heat pump evaporator prior to expansion valve 5 is considered as the residual heat of the heat pump that returns residual heat into the source environment. Such heat pump pumps energy with a high coefficient of performance (COP) irrespective of the large difference in the temperatures of the air heat evaporator 6 and the evaporator 7 of condensate and concentrate heat and the heat pump condenser 2. While the heat pump only compensates for heat losses and creates the temperature difference in the boiling vessel 13 of the distiller, necessary for the functioning of the heat exchange, the temperature of the condensate and concentrate is lower of that of the solution to be distilled by a few degrees as a result of the distillation. The energy in the condensate and concentrate exceeding the level of freezing can be used for other purposes by means of the heat pump.

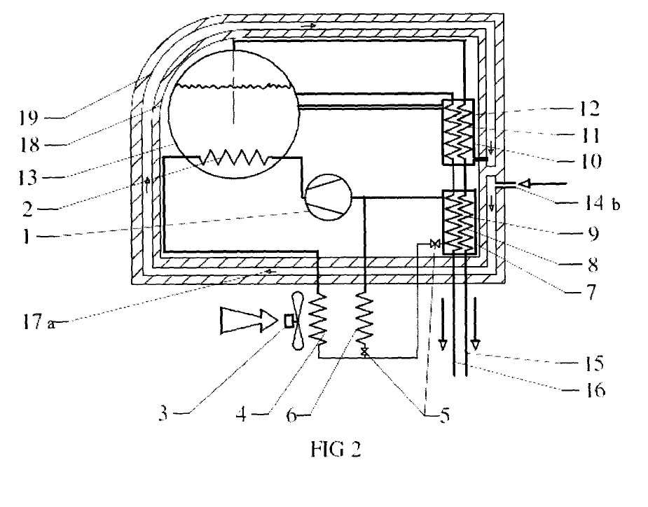

According to another preferred embodiment presented in FIG. 2, a compact stationary distiller, covered with thermal insulation casing 18 is positioned in a closed water jacket 17a of the solution to be distilled. A vessel open from the top, for example could be used for water jacket 17a. The heat loss penetrating the internal thermal insulation jacket 18 of the distiller, pre-heating the cool solution to be distilled surrounded the internal thermal insulation jacket 18. This way the heat loss is recycled.

The need for the thermal insulation of external insulation casing 19 of water jacket 17a surrounding the distiller depends on the temperature of the solution to be distilled and the ambient air temperature around the device and other possible considerations to allow or avoid heat exchange from the surrounding air into the distilled solution through the external casing 19 in water jacket 17a, moving to condenser cooler 10. For example, if the air temperature in the room at the location of the distiller is higher than the temperature of the solution to be distilled and there are no reasons to avoid heat exchange from the ambient air into the solution to be distilled, and the external casing of the water jacket 17a of the distiller may remain without thermal insulation.

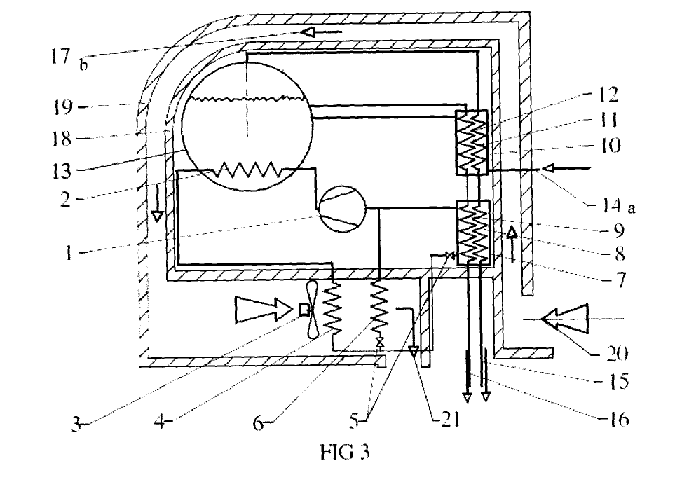

According to one more preferred embodiment, presented in FIG. 3, the distiller is provided with thermal insulation so that there is fan 3, additional heat exchanger 4 of the heat pump, expansion valve 5 of the heat pump and evaporator of the heat pump 6 in the air gap 17b remaining between the internal and external thermal insulation casings 18, 19. The heat loss from the hot parts of the distiller, passing through the internal thermal insulation casing 18 heats the air moving in air gap 17b between the internal and external insulation casings 18 and 19 towards the additional heat exchanger 4 of the heat pump and evaporator 6 of the heat pump.

A method for the recycling of the thermal energy of a distiller, corresponding to the invention, is executed according to the preferred embodiment so that while the solution to be distilled is moving to the boiling vessel 13 of the distiller, it is pre-heated in condenser cooler 10 by means of heat exchange with the vapour, condensate and concentrate coming from boiling vessel 13, at the same time the solution to be distilled condenses the vapour and cools down the condensate and concentrate.

The method for the recycling of the heat losses of a distiller is executed according to the preferred embodiment so that low heat losses penetrating a good-quality thermal insulation could be utilised for heating an environment with a lower temperature, which in case of the preferred embodiments of the distiller would be a low-temperature distilled solution guided into the distiller or air surrounding the distiller and guided into the evaporator of the heat pump. In other words, heat losses are routed to recycling in the energy circulation inside the distiller. According to the invention, there are two options for the recycling of heat losses. The selection of the option for the recycling of heat losses depends on the temperatures of the solution to be distilled and the air of the surrounding environment and on other possible considerations. In case of the preferred embodiments corresponding to this invention, either the solution to be distilled or the air surrounding the distiller constitute such environments.

According to one preferred embodiment of the invention, the method for the recycling of heat losses is executed so that the heat loss from the hot parts of the distiller, penetrating the internal thermal insulation casing 18 of the distiller pre-heats the cool solution to be distilled passing through the water jacket 17a surrounding the distiller and flowing to the condenser cooler 10 of the distiller. According to this preferred embodiment, the additional energy consumption of distilling is reduced by the heat loss utilised in recycling, because the heat loss circulates in the energy circulation loop inside the distiller.

According to one more preferred embodiment of the invention, the method is executed for the recycling of heat losses so that the heat loss from the hot parts of the distiller, penetrating the internal thermal insulation casing 18 is used for heating the air in the air gap 17b between the internal and external thermal insulation casings 18 and 19 of the distiller, moving towards the evaporator 6 of the heat pump. The air heated by the extent of the heat losses increases the evaporation temperature of the coolant of the heat pump in the evaporator 6 of the heat pump by the temperature of the heat loss. The increase of the evaporation temperature of coolant in the evaporator 6 of the heat pump reduces the amount of work of the heat pump compressor. This way the heat loss is recycled, circulating in the energy circulation loop inside the distiller.

In distillers and methods complying with the present invention, the thermal energy and heat losses are repeatedly reused in a closed loop energy circulation. Eliminating the problem of high energy costs, the distiller corresponding to the invention could be utilized for instance in the production of drinking water from the seawater or from any available natural water, as well as at the finishing stage of a less complex wastewater treatment process. The closed loop energy circulation is also applicable in production of spirit, biofuel-spirit, and petrochemicals based on the same principle, reducing considerably the energy intensiveness of these products.

1. A distiller with a closed loop energy circulation, comprising parts of a heat pump and a distiller, the heat pump comprises a heat pump compressor, a heat pump condenser in a boiling vessel of the distiller, a fan, expansion valves of the heat pump, an evaporator of the heat pump, and the distiller contains a boiling vessel of the distiller, an inlet for a solution to be distilled, a distillate outlet, a concentrate outlet, wherein condenser of the distiller is replaced with a condenser cooler that comprises a condensate coil and a concentrate coil and in which the vapour is condensed, the condensate and concentrate are cooled by means of the solution to be distilled, which has entered through an inlet, and wherein the heat pump also containing an additional heat exchanger of the heat pump, evaporator of the condensate and concentrate heat, which incorporates a coil for condensate heat and a coil for concentrate heat, and the solution to be distilled pre-heated in the condenser cooler and heated in the boiling vessel of the distiller is brought to boiling point by means of the heat pump, using residual energy of the condensate and concentrate in the evaporator of the heat pump, exceeding the freezing level after the condenser cooler.

2. The distiller with a closed loop energy circulation according to claim 1, wherein thermal energy for starting and heating the boiling vessel of the distiller is retrieved from air by means of the heat pump evaporator.

3. The distiller with a closed loop energy circulation according to claim 2, wherein the thermal energy for starting and heating the boiling vessel of the distiller is retrieved from heat of ambient air.

4. The distiller with a closed loop energy circulation according to claim 1, wherein the distiller comprises a thermal insulation casing.

5. The distiller with a closed loop energy circulation according to claim 4, wherein the thermal insulation casing of the distiller comprises an internal thermal insulation casing and an external thermal insulation casing.

6. The distiller with a closed loop energy circulation according to claim 5, wherein there is a water jacket between the internal thermal insulation casing and the external thermal insulation casing of the distiller.

7. The distiller with a closed loop energy circulation according to claim 6, wherein the water jacket is a closed vessel, where the solution to be distilled flows through.

8. The distiller with a closed loop energy circulation according to claim 6, wherein the water jacket is an open top vessel, where the solution to be distilled flows through.

9. The distiller with a closed loop energy circulation according to claim 6, wherein the inlet is connected to the condenser cooler of the distiller through the water jacket.

10. The distiller with a closed loop energy circulation according to claim 5, wherein there is an air gap between the internal thermal insulation casing and the external thermal insulation casing of the thermal insulation of the distiller.

11. The distiller with a closed loop energy circulation according to claim 5, wherein a fan, the heat exchanger of the heat pump, the expansion valve and the evaporator of the heat pump are installed inside the external thermal insulation casing.

12. A method for reuse of heat energy and thermal loss of the distiller with a closed loop energy circulation according to claim 1, wherein the vapour coming from the boiling vessel of the distiller is condensed, the condensate and concentrate are cooled in the condenser cooler by passing through the condensate coil and concentrate coil in the opposite direction with the solution to be distilled moving through the medium of the condenser cooler to the boiling vessel, as a result of which the thermal energy contained in the vapour, condensate and concentrate is transferred for recycling in the solution to be distilled moving to the boiling vessel, using the heat pump, while the energy exceeding the freezing level, contained in the condensate and concentrate after the condenser cooler is pumped, using the compressor of the heat pump, from the evaporator of the condensate and concentrate heat to the condenser of the heat pump in the boiling vessel; the thermal energy with low temperature, contained in the condensate and concentrate after the condenser cooler of the distiller, is transferred to recycling in the energy circulation inside the distiller.

13. The method for reuse of heat energy and thermal loss of the distiller according to claim 12, wherein thermal loss from the heat energy of the distiller is used for pre-heating a solution to be distilled that has a temperature lower than the thermal loss temperature, and moves from inlet to the condenser cooler through water jacket, in the course of which the thermal loss in transferred to recycling in the closed loop energy circulation of the distiller.

14. The method for reuse of heat energy and thermal loss of the distiller according to claim 12, wherein thermal loss from the hot parts of the distiller, penetrating the internal thermal insulation casing is used for warming up the air, which moves towards the heat exchanger of the heat pump and evaporator of the heat pump inside the air gap in the external thermal insulation casing, with the lower temperature than the inner surface of the external thermal insulation casing and entering through the inlet of the heat pump, in the course of which the thermal loss is transferred to recycling in the closed loop energy circulation of the distiller by means of a heat pump.

15. The distiller with a closed loop energy circulation according to claim 5, wherein the external insulation casing is not thermally insulated.
